(19) United States
(12) Patent Application Publication
(10) Pub. No.: US 2026/0101382 A1
(43) Pub. Date: Apr. 9, 2026

(54) METHOD AND APPARATUS FOR CONFIGURING TRANSMISSION RESOURCES IN WIRELESS COMMUNICATION SYSTEM

(71) Applicant: ELECTRONICS AND TELECOMMUNICATIONS RESEARCH INSTITUTE, Daejeon (KR)

(72) Inventors: Jung Sun UM, Daejeon (KR); Jae Hyun SEO, Daejeon (KR); SUNG IK PARK, Daejeon (KR)

(73) Assignee: ELECTRONICS AND TELECOMMUNICATIONS RESEARCH INSTITUTE, Daejeon (KR)

(21) Appl. No.: 19/345,800

(22) Filed: Sep. 30, 2025

(30) Foreign Application Priority Data
Oct. 4, 2024 (KR) 10-2024-0135181
Feb. 4, 2025 (KR) 10-2025-0013777
Mar. 21, 2025 (KR) 10-2025-0036757
May 9, 2025 (KR) 10-2025-0060213
Sep. 29, 2025 (KR) 10-2025-0141520

(51) Int. Cl. H04W 74/0833; H04W 72/0446

(52) U.S. Cl. CPC H04W 74/0833; H04W 72/0446

(57) ABSTRACT

A method of a first D node may comprise: transmitting, to an R node, a Msg1 at a first time within a time duration in which transmission of the Msg1 is possible, based on reception of a random access trigger message from the R node; receiving, from the R node, a Msg2 including information on a resource available for transmission of a Msg3; and in response to identifying the received Msg2 as a response to the Msg1, transmitting the Msg3 including information on the first D node to the R node, based on the information on the resource available for transmission of the Msg3, which is included in the Msg2.

### CROSS-REFERENCE TO RELATED APPLICATIONS

This application claims priority to Korean Patent Applications No. 10-2024-0135181, filed on Oct. 4, 2024, No. 10-2025-0013777, filed on Feb. 4, 2025, No. 10-2025-0036757, filed on Mar. 21, 2025, No. 10-2025-0060213, filed on May 9, 2025, and No. 10-2025-0141520, filed on Sep. 29, 2025, with the Korean Intellectual Property Office (KIPO), the entire contents of which are hereby incorporated by reference.

### BACKGROUND

### 1. Technical Field

The present disclosure relates to a wireless communication system, and more particularly, to a technique for configuring transmission resources in a wireless communication system.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

After the commercialization of the fourth-generation (4G) communication system (e.g. communication system supporting LTE), a fifth-generation (5G) communication system (e.g. communication system supporting NR) using not only a frequency band of the 4G communication system (e.g. frequency band below 6 GHz) but also a higher frequency band than the frequency band of the 4G communication system (e.g. frequency band above 6 GHz) is being considered in order to handle the rapid increase in wireless data. The 5G communication system may support enhanced Mobile BroadBand (eMBB), Ultra-Reliable and Low Latency Communication (URLLC), and massive Machine Type Communication (mMTC).

The 5G communication systems can support a data transmission function suitable for service characteristics. The 5G communication system and a data transmission technology for supporting services may vary according to service requirements. However, a basic operation procedure or a signal structure of the 5G communication system is designed so that a technology required for a service under consideration is applied while the basic operation procedure or the signal structure is maintained as much as possible.

As an example of mMTC technology, there are Internet of Things (IoT) services such as logistics verification, process handling, industrial equipment operation monitoring, and equipment control in industries or factories. IoT services are services that can be used across society, such as micro-mobility and electric power measurement. Requirements in a specific field among IoT services may include devices that operate at ultra-low power without an external power supply. An ultra-low-power IoT device may have a function of securing and harvesting electric power from an external energy source, including a surrounding radio signal, for an operation. Therefore, in order to configure and schedule a resource to be transmitted from the ultra-low-power IoT device, a function of securing and harvesting electric power needs to be considered.

### SUMMARY

The present disclosure for resolving the above-described problems is directed to providing a method and apparatus for configuring a transmission resource and scheduling the transmission resource in an ultra-low-power IoT device.

A method of a first device (D) node, according to an exemplary embodiment of the present disclosure, may comprise: transmitting, to a reader (R) node, a first message (Msg1) at a first time within a time duration in which transmission of the Msg1 is possible, based on reception of a random access trigger message from the R node; receiving, from the R node, a second message (Msg2) including information on a resource available for transmission of a third message (Msg3); and in response to identifying the received Msg2 as a response to the Msg1, transmitting the Msg3 including information on the first D node to the R node, based on the information on the resource available for transmission of the Msg3, which is included in the Msg2, wherein the first time is a start time of one Internet of Things (IoT) slot among IoT slots obtained by dividing the time duration from a predefined minimum time for transmission of the Msg1 to a predefined maximum time for transmission of the Msg1.

Based on identifying that an IoT slot index for the Msg1 is included in IoT slot index information of the received Msg2, the received Msg2 may be identified as the response to the Msg1.

The resource available for transmission of the Msg3 may include Msg3 transmission slots having a same number as a number of IoT slots available for transmission of the Msg1, and the Msg3 may be transmitted in a Msg3 transmission slot among the Msg3 transmission slots, the Msg3 transmission slot having a same slot index as a slot index corresponding to the first time at which the Msg1 is transmitted.

The Msg2 may be received within a time duration in which reception of the Msg2 is possible, the time duration in which reception of the Msg2 is possible being determined based on a predefined maximum time for a first IoT slot among the IoT slots and a predefined minimum time for a last IoT slot among the IoT slots.

The Msg2 may further include a first time offset for calculating a start time of transmission of the Msg3; based on the first time offset being non-zero, the start time of transmission of the Msg3 may be determined based on an end time of transmission of the Msg2 and the first time offset; and based on the first time offset being zero, the start time of transmission of the Msg3 may be determined based on the end time of transmission of the Msg2.

The Msg3 may be transmitted at a second time, the second time may correspond to a start time of one slot among a plurality of slots; a first slot among the plurality of slots may be determined based on an end time of transmission of the Msg2, a first time offset included in the Msg2, and a predefined minimum time for transmission of the Msg3; and a last slot among the plurality of slots may be determined based on the end time of transmission of the Msg2, the first time offset included in the Msg2, and a predefined maximum time for transmission of the Msg3. The Msg2 may further include two or more first time offsets indicating start times of transmission of the Msg3 and mapping information between the two or more first time offsets and respective D nodes; and based on existence of a first time offset mapped to the first D node, the Msg3 may be transmitted at a time determined based on the first time offset mapped to the first D node.

The first time may be determined as an IoT slot index corresponding to a randomly generated number within a range of a number of the IoT slots.

A method of a reader (R) node, according to an exemplary embodiment of the present disclosure, may comprise: broadcasting a trigger message instructing performance of a random access (RA) procedure; receiving, from a device (D) node, a first message (Msg1) within a time duration in which transmission of the Msg1 is possible in response to the trigger message; and transmitting, to the D node, a second message (Msg2) including information on a resource available for transmission of a third message (Msg3) and response information for the Msg1, based on the received Msg1, wherein the D node transmits the Msg1 at a first time, and the first time is a start time of one Internet of Things (IoT) slot among IoT slots obtained by dividing the time duration from a predefined minimum time for transmission of the Msg1 to a predefined maximum time for transmission of the Msg1.

The response information for the Msg1 may be indicated by a same slot index as a slot index of the Msg1 transmitted by the D node.

The resource available for transmission of the Msg3 may include Msg3 transmission slots having a same number as a number of IoT slots available for transmission of the Msg1, and the Msg3 may be received in a Msg3 transmission slot among the Msg3 transmission slots, the Msg3 transmission slot having a same slot index as a slot index corresponding to the first time at which the Msg1 is received.

The Msg2 may be transmitted within a time duration in which transmission of the Msg2 is possible, the time duration in which transmission of the Msg2 is possible being determined based on a predefined maximum time for a first slot among the IoT slots and a predefined minimum time for a last slot among the IoT slots.

The Msg2 may further include a first time offset for calculating a start time of transmission of the Msg3; based on the first time offset being non-zero, the start time of transmission of the Msg3 may be determined based on an end time of transmission of the Msg2 and the first time offset; and based on the first time offset being zero, the start time of transmission of the Msg3 may be determined based on the end time of transmission of the Msg2.

The Msg3 may be received at a second time, the second time may correspond to a start time of one slot among a plurality of slots; a first slot among the plurality of slots may be determined based on an end time of transmission of the Msg2, a first time offset included in the Msg2, and a predefined minimum time for transmission of the Msg3; and a last slot among the plurality of slots may be determined based on the end time of transmission of the Msg2, the first time offset included in the Msg2, and a predefined maximum time for transmission of the Msg3.

The Msg2 may further include two or more first time offsets indicating start times of transmission of the Msg3 and mapping information between the two or more first time offsets and respective D nodes.

The first time may be determined as an IoT slot index corresponding to a randomly generated number within a range of a number of the IoT slots.

A first D node according to an exemplary embodiment of the present disclosure may comprise at least one processor, wherein the at least one processor may cause the first D node to perform: transmitting, to a reader (R) node, a first message (Msg1) at a first time within a time duration in which transmission of the Msg1 is possible, based on reception of a random access trigger message from the R node; receiving, from the R node, a second message (Msg2) including information on a resource available for transmission of a third message (Msg3); and in response to identifying the received Msg2 as a response to the Msg1, transmitting the Msg3 including information on the first D node to the R node, based on the information on the resource available for transmission of the Msg3, which is included in the Msg2, wherein the first time is a start time of one Internet of Things (IoT) slot among IoT slots obtained by dividing the time duration from a predefined minimum time for transmission of the Msg1 to a predefined maximum time for transmission of the Msg1.

Based on identifying that an IoT slot index for the Msg1 is included in IoT slot index information of the received Msg2, the received Msg2 may be identified as the response to the Msg1.

The resource available for transmission of the Msg3 may include Msg3 transmission slots having a same number as a number of IoT slots available for transmission of the Msg1, and the Msg3 may be transmitted in a Msg3 transmission slot among the Msg3 transmission slots, the Msg3 transmission slot having a same slot index as a slot index corresponding to the first time at which the Msg1 is transmitted.

The Msg2 may be received within a time duration in which reception of the Msg2 is possible, the time duration in which reception of the Msg2 is possible being determined based on a predefined maximum time for a first IoT slot among the IoT slots and a predefined minimum time for a last IoT slot among the IoT slots.

In an IoT system, an R node may trigger a random access procedure of a D node, and the D node may transmit a first message to the R node based on the triggering of the random access procedure, and may transmit a third message based on a second message that the R node transmits in response to the first message. In the present disclosure, by defining a transmission time of the first message, a transmission time of the second message, and a transmission time of the third message, the IoT system can perform communication suitable when the IoT system is applied to a mobile communication system. In addition, there is an advantage in that smooth communication can be performed based on control information that the R node transmits to the D node when the D node performs communication after being connected to the R node.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram illustrating IoT communication nodes in an IoT communication network.

FIG. 3B is a conceptual diagram illustrating a case where IoT nodes are included in a wireless communication network.

FIG. 4 is a conceptual diagram of a frame structure used for an RD transmission or a DR transmission in an IoT system.

FIG. 5A is a conceptual diagram illustrating signal intervals for a transmission of a response corresponding to a first RD transmission and a transmission for a second RD transmission in an IoT system.

FIG. 5B is a conceptual diagram illustrating signal intervals for a transmission of a response corresponding to a first DR transmission and a transmission for a second DR transmission in an IoT system.

FIG. 6 is a conceptual diagram illustrating timing at which a DR transmission is performed based on control information included in an RD transmission in an IoT system.

FIG. 7A is a conceptual diagram according to a first exemplary embodiment for determining a DR transmission time based on an RD transmission in an IoT system.

FIG. 7B is a conceptual diagram according to a second exemplary embodiment for determining a DR transmission time based on an RD transmission in an IoT system.

FIG. 8 is a conceptual diagram illustrating a first exemplary embodiment in which an R node instructs two or more D nodes to perform DR transmissions in an IoT system.

FIG. 9 is a conceptual diagram illustrating a second exemplary embodiment in which an R node instructs two or more D nodes to perform DR transmissions in an IoT system.

FIG. 10 is a conceptual diagram illustrating an exemplary embodiment of a configuration of T_R2D in an IoT system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

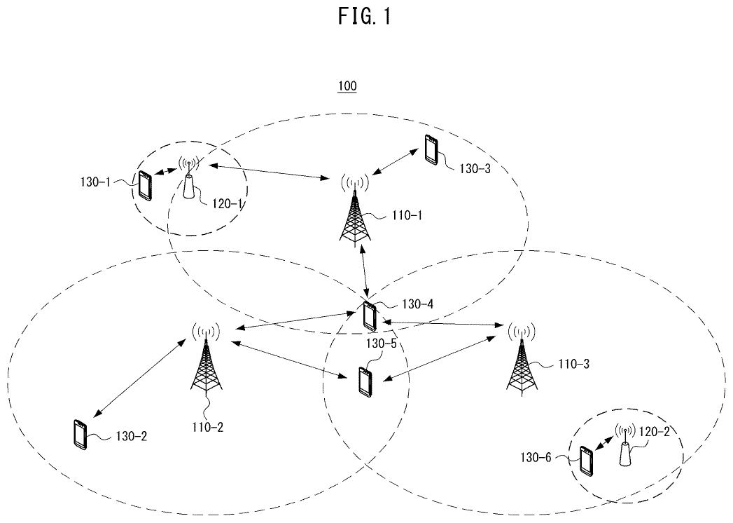

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication and 5G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

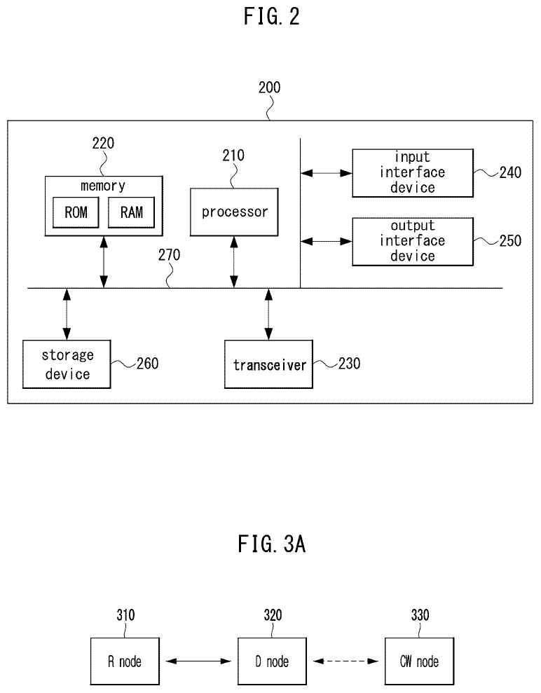

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

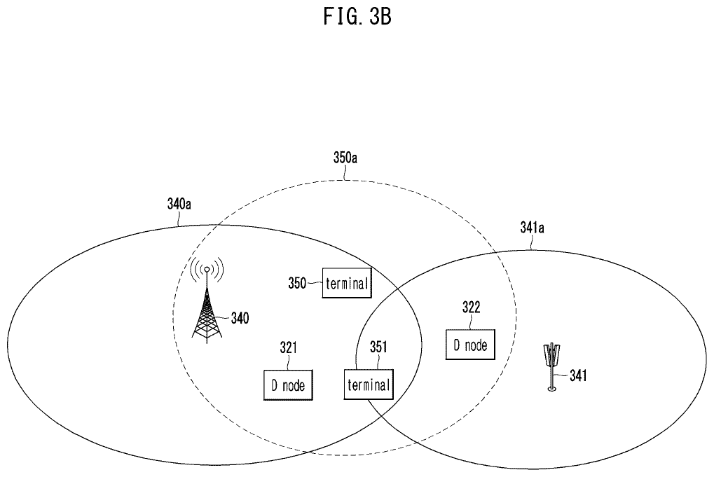

FIG. 3A is a conceptual diagram illustrating IoT communication nodes in an IoT communication network.

Referring to FIG. 3A, an R node 310, a D node 320, and a CW node 330 are illustrated. In FIG. 3A, for convenience of description and convenience of understanding, only one communication node for each of the nodes 310, 320, and 330 is illustrated. However, a plurality of nodes may be included in a communication network. For example, a configuration may include two or more R nodes, two or more D nodes, and/or two or more CW nodes.

The R node 310 may refer to a reader node, and may be referred to as ‘R node’, ‘reader node’, or ‘R-node’. The D node 320 may refer to an IoT terminal or an IoT node, and may be referred to as ‘IoT terminal’, ‘IoT node’, ‘I node’, ‘I-node’, ‘device’, ‘D node’, or ‘D-node’. The CW node 330 may refer to a node that transmits a carrier wave (CW), and may be referred to as ‘CW node’, ‘CW-node’, or ‘CW terminal’.

The R node 310 and the D node 320 may communicate based on an IoT scheme. For example, the R node 310 may transmit control information, data, scheduling information, and the like to the D node 320, and may receive a signal (or data) transmitted from the D node 320 in a backscattering scheme (e.g. back-scattering).

The CW node 330 may be a communication node that transmits a CW so that the D node 320 can transmit a signal in the backscattering scheme. The CW node 330 may be a device having power that is always supplied or having a large-capacity battery. The CW node 330 may transmit the CW according to a request of the R node 310, may transmit the CW at a preset periodicity, or may transmit the CW continuously.

The D node 320 may be a low-power device or an ultra-low-power device. In other words, the D node 320 may be a node having no energy source or having a limited energy source, for example, a small battery. The D node 320 may receive the CW transmitted by the CW node 330 and may aggregate (or collect or harvest) energy from the CW. The D node 320 may transmit data to the R node 310 in the backscattering scheme by using the aggregated (or collected or harvested) energy.

FIG. 3B is a conceptual diagram illustrating a case where IoT nodes are included in a wireless communication network.

Referring to FIG. 3B, a wireless communication network may include a first base station 340 and a second base station 341. The first base station 340 may have a coverage area 340a based on a signal delivery distance of the first base station 340, and the second base station 341 may also have a coverage area 341a based on a signal delivery distance of the second base station 341.

According to the example of FIG. 3B, a first terminal 350 and a second terminal 351 may be located within the first coverage area 340a of the first base station 340, and the second terminal 351 may be located within the second coverage area 341a of the second base station 341. A first D node 321, which is an IoT terminal, may be located within the first coverage area 340a of the first base station 340, and a second D node 322, which is another IoT terminal, may be located within the second coverage area 341a of the second base station 341.

Each of the base stations 340 and 341 illustrated in FIG. 3B may be one among the plurality of base stations 110-1, 110-2, 110-3, 120-1, and 120-2 described with reference to FIG. 1, and each of the terminals 350 and 351 may be one among the plurality of terminals 130-1, 130-2, 130-3, 130-4, 130-5, and 130-6 described with reference to FIG. 1. Therefore, each of the base stations 340 and 341 and/or each of the terminals 350 and 351 may include all or some of the components described with reference to FIG. 2.

In FIG. 3B, the R node 310 in FIG. 3A is not illustrated. When IoT nodes are included in the wireless communication network as in FIG. 3B, one or more base stations among the base stations 340 and 341 or one or more terminals among the terminals 350 and 351 may operate as the R node.

When at least one among the base stations 340 and 341 and/or the terminals 350 and 351 operates as the R node, the communication node operating as the R node may further include an additional component in addition to the components described with reference to FIG. 2. For example, each of the base stations 340 and 341 and/or each of the terminals 350 and 351 may further include a component to perform communication based on the IoT scheme with at least one D node among the D nodes 321 and 322. In addition, at least one among the base stations 340 and 341 and/or the terminals 350 and 351 may further include a component to transmit a CW to at least one D node among the D nodes 321 and 322.

### In-Service Condition and Out-of-Service Condition

### a) D Node Satisfying In-Service Condition

In the example of FIG. 3B, it is assumed that the first base station 340 is able to communicate with one or more D nodes based on the IoT communication scheme. Therefore, the first base station 340 may serve as an R node. In addition, the first base station 340 may serve as a CW node. Depending on a condition, the second base station 341 may serve as a CW node for the D node(s) communicating with the first base station 340.

As illustrated in FIG. 3B, the first D node 321 may be located within the first coverage area 340a of the first base station 340. When the first D node 321 is able to communicate with the first base station 340 based on the IoT communication scheme, the first D node 321 may be a D node satisfying “inside-service condition” or “in-service condition”.

A CW signal for the first D node 321 satisfying the in-service condition to perform communication with the first base station 340 based on the IoT communication scheme may be received from the first base station 340. In another example, a CW signal for the first D node 321 satisfying the in-service condition to perform communication with the first base station 340 based on the IoT communication scheme may be received from the second base station 341. In another example, a CW signal for the first D node 321 satisfying the in-service condition to perform communication with the first base station 340 based on the IoT communication scheme may be received from one among the adjacent terminals 350 and 351.

### b) D Node Satisfying Out-of-Service Condition

As illustrated in FIG. 3B, the second D node 322 may be located outside the first coverage area 340a of the first base station 340. Since the second D node 322 is located outside the first coverage area 340a of the first base station 340, the second D node 322 may not be able to communicate with the first base station 340 based on the IoT communication scheme. A D node that is not able to communicate with a base station may be referred to as a D node satisfying “out-of-service condition”.

The first D node 321 and the second D node 322 may operate in low power. In such a case, even when the first D node 321 is able to receive data from the first base station 340, if the first D node 321 has a signal strength lower than a reference signal strength required to transmit data to the first base station 340 without error, the first D node 321 may be a D node satisfying the out-of-service condition. Hereinafter, for convenience of description, the D node satisfying the out-of-service condition is described as the second D node 322.

Since the second D node 322 satisfying the out-of-service condition is not able to communicate directly with the first base station 340, the second D node 322 may perform indirect communication via one terminal among the adjacent terminals 350 and 351. For example, the first base station 340 may use the first terminal 350 to communicate with the second D node 322 satisfying the out-of-service condition. In such a case, the first terminal 350 may operate as an R node for the second D node 322.

The first terminal 350 operating as the R node for the second D node 322 satisfying the out-of-service condition may perform R node operations described below. In addition, the first terminal 350 operating as the R node for the second D node 322 may also operate as a CW node. In another example, the CW node for the second D node 322 may be the second terminal 351 instead of the first terminal 350 operating as the R node.

Since the second D node 322 satisfying the out-of-service condition is not able to communicate directly with the first base station 340, the second D node 322 may communicate with the first base station 340 by using the adjacent second base station 341. For example, the second D node 322 satisfying the out-of-service condition may receive data from the first base station 340 and may transmit data destined for the first base station 340 to the adjacent second base station 341. In this case, a communication node operating as a CW node for the second D node 322 may be the second base station 341. In another example, the communication node operating as the CW node for the second D node 322 may be one terminal among the first terminal 350 and the second terminal 351.

### Links and Operating Environments of IoT Nodes

When IoT nodes are included in a wireless communication network, as described in FIG. 3A, the configuration may include the R node 310, D node 320, and CW node 330. In addition, as described in FIG. 3B, the R node and the CW node may be implemented as a single node. For example, a node operating as the R node and the CW node may be one among the base stations 340 and 341 and the terminals 350 and 351. In other words, the R node and the CW node may be physically configured as one identical node.

In a wireless communication system, a link through which a base station transmits a signal to a terminal may be a downlink (DL), and a link through which a terminal transmits a signal to a base station may be an uplink (UL).

### a) Links, Transmissions, and Transmission Resources Among IoT Nodes

In the present disclosure described below, a link for transmitting a signal from the R node 310 to the D node 320 based on the IoT communication scheme is defined as an “RD link”, a link for transmitting a signal from the D node 320 to the R node 310 is defined as a “DR link”, and a link through which the CW node 330 transmits a CW to the D node 320 is defined as a “CWD link”. In addition, in the present disclosure described below, each of the RD link, the DR link, and the CWD link may indicate a connection between two nodes, and a signal transmitted through the corresponding link may be referred to as RD transmission, DR transmission, or CWD transmission. In the present disclosure, “transmission” may indicate that a radio resource is occupied and an actual signal is transmitted through the occupied radio resource. For example, an RD transmission may refer to a signal or a signal set transmitted from the R node to the D node during a time duration (e.g. one or more slots).

In addition, in the present disclosure described below, a transmission resource of the RD link, a transmission resource of the DR link, and a transmission resource of the CWD link may each indicate a resource region capable of transmitting a signal through the corresponding link. Therefore, each of the RD transmission, the DR transmission, and the CWD transmission may refer to a resource in which an actual transmission is performed within the transmission resource of the RD link, the transmission resource of the DR link, and the transmission resource of the CWD link. In the following description, for convenience of description, a case in which the RD transmission, the DR transmission, or the CWD transmission is performed over the entire transmission resource of the RD link, the DR link, or the CWD link is assumed. In other words, unless a transmission and a transmission region are explicitly distinguished, a transmission resource region and a transmission resource are assumed to be identical.

### b) Operating Environments of IoT Nodes

The IoT nodes may operate in a Frequency Division Duplex (FDD) manner. In an environment operating in the FDD manner, the RD link may be configured in a downlink of FDD. In other words, the R node 310 may transmit a signal to the D node 320 through the downlink of FDD. The DR link may also be configured in the downlink of FDD. In other words, the R node 310 may receive a signal from the D node 320 through the downlink of FDD. The case where the RD link and the DR link are configured in the same downlink of FDD may correspond to a case where the D node 320 has difficulty performing frequency conversion or frequency shifting. When the RD link and the DR link are configured in the same downlink, the CWD link may also be configured in the same downlink.

In another example, in an environment operating in the FDD manner, the RD link may be configured in an uplink of FDD. In other words, the R node 310 may transmit a signal to the D node 320 through the uplink of FDD. The DR link may also be configured in the uplink of FDD. In other words, the R node 310 may receive a signal from the D node 320 through the uplink of FDD. The case where the RD link and the DR link are configured in the same uplink of FDD may correspond to a case where the D node 320 has difficulty performing frequency conversion or frequency shifting. When the RD link and the DR link are configured in the same uplink, the CWD link may also be configured in the same uplink.

On the other hand, when D node 320 is able to perform frequency conversion or frequency shifting, the RD link may be configured in the downlink and the DR link may be configured in the uplink.

### Energy Harvesting

The D node 320 may include at least the processor 210, the memory 220, and the transceiver 230 among the components of FIG. 2. The transceiver 230 may be a device that receives a signal transmitted by the R node 310 based on the IoT communication scheme and transmits a signal to the R node 310 through backscattering. The D node 320 may harvest energy through a wireless signal or may harvest energy from another external energy source. For this purpose, the D node 320 may further include an energy harvesting device in addition to the components described above. The energy harvesting device may harvest energy for the D node 320 by using a signal received from the CW node 330. The energy harvesting device or the processor 210 may manage the harvested energy. Depending on an amount of energy harvested by the energy harvesting device (a harvested energy level), operations of the transceiver 230 may be limited. Therefore, the D node 320 may operate in one among the three modes below.

### a) On Mode

The D node 320 may operate in an on mode when the amount of energy harvested by the energy harvesting device (i.e. harvested energy level) is equal to or greater than a preset first threshold. The D node 320 may transmit and/or receive a signal in the on mode. In the on mode, the D node 320 may store and maintain at least data or information related to a signal transmission operation and/or a signal reception operation. Here, the data or the information may be instantaneous or temporary data or information required for operations of the D node 320 including signal transmission and reception. In the on mode, the D node 320 may maintain information related to a time clock of the D node 320 or maintain a clock operation of the D node 320. The time clock may be implemented in software in the processor 210 or may be provided by a physical clock device.

### b) Sleep Mode

The D node 320 may operate in a sleep mode when the amount of energy harvested by the energy harvesting device (i.e. harvested energy level) is less than the preset first threshold and is equal to or greater than a preset second threshold. The D node 320 may maintain at least a clock for a specific purpose in the sleep mode. Here, the specific purpose may indicate an operation required at a specific time. For example, when a signal needs to be received from the R node 310 by transitioning to the on mode at the specific time, the clock may be maintained for transitioning to the on mode at the specific time. Here, the specific time may include at least one among a time determined based on a fixed one-time interval set by the R node 310 and a time determined based on a periodicity set by the R node 310. In the sleep mode, the D node 320 may transition to another mode based on the clock for the specific purpose and an operation corresponding to the clock. In this case, the time clock may be implemented in software in the processor 210 or may be provided by a physical clock device. When the D node 320 is in the sleep mode, the energy harvesting device may be in a state of harvesting energy. Since the state where the D node 320 is in the sleep mode may be interpreted as a state waiting for a transition to a next state, the state according to the sleep mode may be referred to as a “standby state”.

### c) Off Mode

The D node 320 may transition to an off mode when the amount of energy harvested by the energy harvesting device (i.e. harvested energy level) is less than the second threshold. The off mode may indicate a state in which the D node 320 is not able to transmit a signal and is not able to receive a signal. In other words, when the D node 320 is in the off mode, the D node 320 may maintain only minimum information required for the D node 320. When the D node 320 is in the off mode, the energy harvesting device may be in a state of harvesting energy. Since the D node 320 does not operate in the off mode, the state according to the off mode may be referred to as a “suspended state”.

The D node 320 may operate in one of the three modes described above, and the first threshold and the second threshold, which are energy levels serving as criteria for the respective modes, may differ depending on an implementation and/or configuration scheme of the D node 320.

### PRDCH/PDRCH

Hereinafter, RD transmission and DR transmission are described.

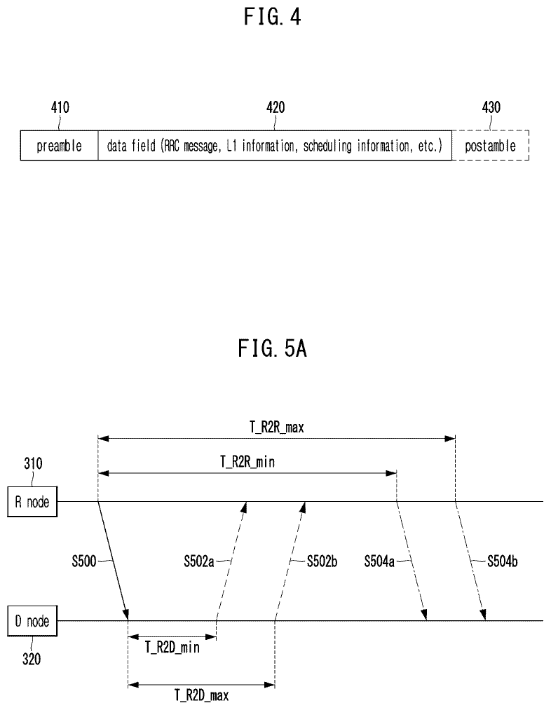

FIG. 4 is a conceptual diagram of a frame structure used for an RD transmission or a DR transmission in an IoT system.

Referring to FIG. 4, a frame used for an RD transmission or a DR transmission may include a preamble 410, a data field 420, and a postamble 430. The postamble 430 may be used optionally, and it should be noted that the postamble 430 is illustrated by a dotted line to indicate optional use. The preamble 410 may be configured as a sequence or pattern for indicating a start of the frame used for the RD transmission or the DR transmission. The preamble 410 may be used for a purpose of detecting that the frame is transmitted at a reception node. For example, in the case of the RD transmission, the D node 320 may recognize that the R node 310 transmits data by detecting the preamble 410. In the case of the DR transmission, the R node 310 may recognize that the D node 320 transmits data by detecting the preamble 410. Various types of sequences or patterns may be used as the sequence or pattern configuring the preamble 410, and the present disclosure does not impose a specific restriction on the sequence or pattern.

As illustrated in FIG. 4, the data field 420 may be transmitted after the preamble 410. The data field 420 may include at least one piece of information among information described below.
a) First layer (Layer 1, L1) control information that is physical layer control information;
b) Radio resource control (RRC) message that is higher-layer control information; or
c) Payload of a higher-layer.

In the present disclosure, the payload of the higher-layer may be an information message destined for the D node 320 that is an IoT terminal. The information message destined for the IoT terminal may include, for example, a specific request message such as an inventory message related to inventory of a factory.

In the case of the RD transmission, the data field 420 may be understood as a specific channel. For example, in the case of the RD transmission, the data field 420 may be understood as a Physical Reader to Device Channel (PRDCH). In the following description, the data field 420 of the RD transmission is described by being referred to as a PRDCH. In addition, the data field 420 of the DR transmission may also be understood as a specific channel. For example, the data field 420 of the DR transmission may be understood as a Physical Device to Reader Channel (PDRCH). In the following description, the data field 420 of the DR transmission is described by being referred to as a PDRCH.

The postamble 430 may be transmitted optionally after the data field 420. The postamble 430 may be configured as a sequence or pattern for indicating an end of the frame used for the RD transmission or the DR transmission. The postamble 430 may be used for a purpose of detecting an end of transmission of the frame at a reception node. In other words, in the case of the RD transmission, the D node 320 may recognize that data transmission from the R node 310 is completed by detecting the postamble 430. In the case of the DR transmission, the R node 310 may recognize that data transmission from the D node 320 is completed by detecting the postamble 430. Various types of sequences or patterns may be used as the sequence or pattern configuring the postamble 430, and the present disclosure does not impose a specific restriction on the sequence or pattern of the postamble 430.

### Transmission Interval

A response signal corresponding to the RD transmission or the DR transmission may be transmitted. For example, in the case of the RD transmission, the R node 310 may transmit a signal or a frame to the D node 320. When the D node 320 receives the signal or the frame from the R node 310, the D node 320 may transmit a response thereto. The opposite case may also proceed in the same manner. For example, in the case of the DR transmission, the D node 320 may transmit a signal or a frame to the R node 310. When the R node 310 receives the signal or the frame from the D node 320, the R node 310 may transmit a response thereto. In such a case, a signal transmission interval may be defined.

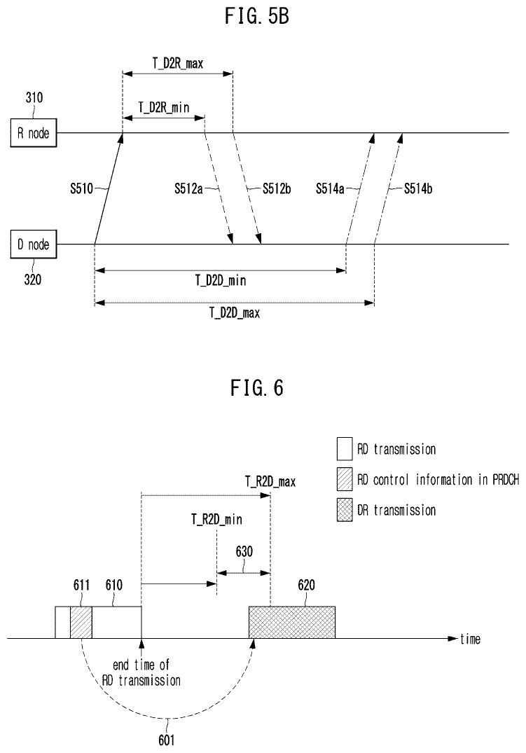

FIG. 5A is a conceptual diagram illustrating signal intervals for a transmission of a response corresponding to a first RD transmission and a transmission for a second RD transmission in an IoT system.

In FIG. 5A, the R node 310 and the D node 320 use the configuration described with reference to FIG. 3A, and the R node 310 and the D node 320 illustrated in FIG. 5A may also be applied to the wireless communication system as described with reference to FIG. 3B. In the description of FIG. 5A, a case where the D node 320 is in the on mode described earlier is assumed. In step S500, the R node 310 may perform a first RD transmission to the D node 320. The D node 320 may receive the first RD transmission from the R node 310. The D node 320 may perform a DR transmission to the R node 310 as a response to the first RD transmission. As illustrated in FIG. 5A, the DR transmission transmitted by the D node 320 as the response to the first RD transmission may be transmitted at a time S502a corresponding to a time interval set to a minimum response time (i.e. T_R2D_min) of the DR transmission for the RD transmission, or may be transmitted at a time S502b corresponding to a time interval set to a maximum response time (i.e. T_R2D_max) of the DR transmission for the RD transmission.

T_R2D_min has been described as a minimum time interval from the RD transmission to the DR transmission, but T_R2D_min may also be applied to a case where the DR transmission is not a response to the RD transmission. In other words, the D node 320 may transmit the DR transmission at a time delayed by at least T_R2D_min from a reception time of the RD transmission received before the DR transmission.

T_R2D_max has been described as a maximum time interval from the RD transmission to the DR transmission, but T_R2D_max may also be applied to a case where the DR transmission is not a response to the RD transmission. In other words, the D node 320 may transmit the DR transmission at a time within T_R2D_max from the reception time of the RD transmission received before the DR transmission.

In step S504a or step S504b, the R node 310 may perform a second RD transmission to the D node 320. The D node 320 may receive the second RD transmission from the R node 310 in step S504a or step S504b.

Step S504a may be performed based on a time set by T_R2R_min. T_R2R_min may be a minimum time interval between two different adjacent RD transmissions that the R node 310 transmits to one D node.

Step S504b may be performed based on a time set by T_R2R_max. T_R2R_max may be a maximum time interval between two different adjacent RD transmissions that the R node 310 transmits to one D node.

FIG. 5B is a conceptual diagram illustrating signal intervals for a transmission of a response corresponding to a first DR transmission and a transmission for a second DR transmission in an IoT system.

In FIG. 5B as well, the R node 310 and the D node 320 are described using the configuration described with reference to FIG. 3A. In addition, the R node 310 and the D node 320 illustrated in FIG. 5B may also be applied to the wireless communication system as described with reference to FIG. 3B. In the description of FIG. 5B, a case where the D node 320 is in the on mode described earlier is assumed.

In step S510, the D node 320 may perform a first DR transmission to the R node 310. The R node 310 may receive the first DR transmission from the D node 320. The R node 310 may perform an RD transmission to the D node 320 as a response to the first DR transmission. As illustrated in FIG. 5B, the RD transmission transmitted by the R node 310 as the response to the first DR transmission may be transmitted at a time S512a corresponding to a time interval set to T_D2R_min or may be transmitted at a time S512b corresponding to a time interval set to T_D2R_max.

T_D2R_min in step S512a may indicate a minimum time interval from the DR transmission to the RD transmission. T_D2R_min may also be applied to a case where the RD transmission is not a response to the DR transmission. In other words, the R node 310 may transmit the RD transmission at a time delayed by at least T_D2R_min from a reception time of the DR transmission received before the RD transmission.

T_D2R_max in step S512b may indicate a maximum time interval from the DR transmission to the RD transmission. T_D2R_max may also be applied to a case where the RD transmission is not a response to the DR transmission. In other words, the R node 310 may transmit the RD transmission at a time within T_D2R_max from the reception time of the DR transmission received before the RD transmission.

In step S514a or step S514b, the D node 320 may perform a second DR transmission to the R node 310. The R node 310 may receive the second DR transmission from the D node 320 in step S514a or step S514b.

Step S514a may be performed based on a time set by T_D2D_min. T_D2D_min may be a minimum time interval between two different adjacent DR transmissions that the D node 320 transmits to the same R node.

Step S514b may be performed based on a time set by T_D2D_max. T_D2D_max may be a maximum time interval between two different adjacent DR transmissions that the D node 320 transmits to the same R node.

The time values described above, for example, T_R2D_min, T_R2D_max, T_R2R_min, T_R2R_max, T_D2D_min, T_D2D_max, T_D2R_min, and T_D2R_max, may be configured to be identical in both the R node 310 and the D node 320.

When two or more D nodes that communicate with one R node 310 based on the IoT scheme exist, not only the R node but also all of the D nodes may have the time values described above configured identically.

In another example, when one or more R nodes and a plurality of D nodes form one IoT network, the time values described above may be configured to be identical in all the nodes configuring the one IoT network.

In another example, when two or more D nodes that communicate with the R node 310 based on the IoT scheme exist, the time values described above may be configured differently for each of the D nodes. In such a case, when one or more R nodes and the plurality of D nodes form one IoT network, the time values described above may be configured differently for each pair of the R node and the D node.

In another example, the time values described above may be configured to have different values depending on a type of message transmitted from the R node to the D node and/or a type of message transmitted from the D node to the R node.

The time values described above may be configured or indicated to the D node by the base station or the R node through a higher-layer message or may be configured or indicated in control information included in a PRDCH.

### Scheduling and Transmission

The R node 310 may deliver resource configuration information for a DR transmission to the D node 320 through a PRDCH. The resource configuration information may be delivered as L1 control information or may be delivered as an RRC message. The L1 control information may be configured separately from a higher-layer message (or data) in the PRDCH or may be configured together with a higher-layer message in the PRDCH.

That the L1 control information is configured separately from a higher-layer message in the PRDCH may mean that a separate CRC is configured only for the control information or that the L1 control information is not considered in a CRC of the higher-layer message.

That the L1 control information may be configured together with a higher-layer message in the PRDCH may mean that a CRC is configured by simultaneously considering the higher-layer message and the L1 control information.

The CRC may not be configured when a length (size) of bits of the higher-layer message and/or the control information is smaller than an arbitrary condition. In other words, when the length (size) of bits of the higher-layer message and/or the control information is smaller than the arbitrary condition, transmission may be performed “without CRC (No-CRC)”.

When the resource configuration information is delivered as the L1 control information or scheduling information for a DR transmission is delivered, the R node 310 may include one or more pieces of information among the following information in the resource configuration information or the scheduling information.
1) Time domain resources
2) Frequency domain resources
3) Modulation and coding rate related information (MCS-like information)
4) Chip duration information
5) Device identifier (Device ID-ID associated with device(s))
6) Repetition information

The scheduling information exemplified above may be dynamic scheduling information.

The resource configuration information may be transmitted from the R node 310 to the D node 320 through an RRC message as a higher-layer message. In the following description, the higher-layer message is described by being referred to as an RRC message. The RRC message may indicate control information indicated or configured at a higher layer of the R node 310 or a network. The RRC message may be static scheduling information. The RRC message may include one or more pieces of information among the following information.
1) Time domain resource information: a periodicity of time domain resource configuration and/or a length of time domain resources
2) Slotted Aloha related parameter information: random value window The D node 320 may receive the RRC message, which is the static scheduling information including the information described above, from the R node 310. The D node 320 may perform a DR transmission at a time of the resource configured based on the received RRC message.

The D node 320 may receive all or part of the static scheduling information from the base station or the R node 310 through the RRC message. In addition, the D node 320 may receive the L1 control information, which is the dynamic scheduling information, from the base station or the R node 310. The D node 320 may determine a DR transmission resource and/or a DR transmission time based on the received RRC message and the L1 control information. For example, the D node 320 may determine a position or a time of a time resource for transmitting the DR transmission based on frequency resource information configured as the static scheduling information and frequency resource information indicated in the dynamic scheduling information.

### DR Transmission Response According to RD Transmission

As described above, the R node 310 may transmit, to the D node 320, an RD transmission including dynamic scheduling information for a DR transmission through a PRDCH. The dynamic scheduling information may be L1 control information and, as described with reference to FIG. 4, may be transmitted by being included in the data field 420.

The D node 320 may perform the DR transmission in a resource allocated (or designated) through the L1 control information. The D node 320 may determine a start time of the DR transmission. When determining the start time of the DR transmission, as described with reference to FIG. 5A, the D node 320 may determine the start time of the DR transmission in a time duration between T_R2D_min and T_R2D_max after the RD transmission. In this case, T_R2D_min and T_R2D_max may be defined (or set) in advance before the RD transmission.

The D node 320 may perform the DR transmission after a time duration set by T_R2D_min from an end time of the RD transmission and within a time duration set by T_R2D_max from the end time of the RD transmission. In this case, the end time of the RD transmission needs to be defined.

According to an exemplary embodiment, the D node 320 may determine the end time of the RD transmission as a time at which the postamble 430 of the RD transmission ends.

According to another exemplary embodiment, the D node 320 may determine the end time of the RD transmission as a time at which it is determined that on-off keying (OOK) signals of the RD transmission do not exist for a certain time. In this case, the certain time may be an OFDM symbol length.

According to another exemplary embodiment, the D node 320 may determine the end time of the RD transmission as a time at which it is determined that OOK signals of the RD transmission are not configured according to valid Manchester Encoding (ME). A case where the OOK signals are not configured according to valid ME may be, for example, a case where ON symbols or OFF symbols appear continuously for a preset certain length or a preset certain time. In a more specific example, when two information bits are Manchester-encoded into four ON/OFF symbols within one OFDM symbol duration, and the four ON/OFF symbols are configured in an OOK scheme, the D node 320 may determine that the PRDCH is terminated if three consecutive ON symbols or three consecutive OFF symbols appear. Based on this determination of PRDCH termination, the D node 320 may regard the end time of the PRDCH as the end time of the last OFDM symbol that contains any valid OOK symbol(s) of the PRDCH. The OFDM symbol that constitutes the end time of the PRDCH may correspond to the final OFDM symbol among the OFDM symbols containing valid OOK symbol(s) of the PRDCH.

According to another exemplary embodiment, the D node 320 may determine the end time of the RD transmission based on the L1 control information related to configuration of the PRDCH.

Based on one of the methods described above, the D node 320 may determine the time corresponding to T_R2D_min and/or the time corresponding to T_R2D_max based on the end time of the RD transmission.

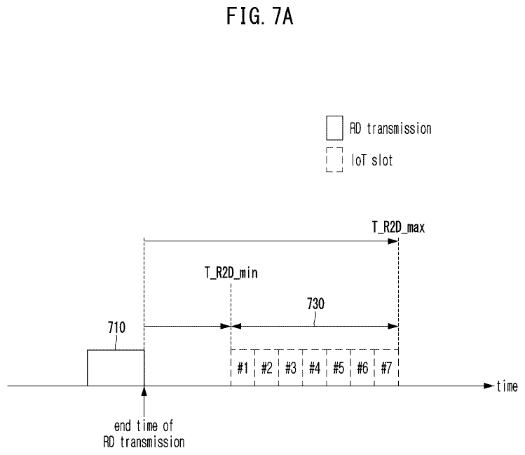

FIG. 6 is a conceptual diagram illustrating timing at which a DR transmission is performed based on control information included in an RD transmission in an IoT system.

Referring to FIG. 6, the R node 310 may transmit an RD transmission 610 to the D node 320. The RD transmission 610 may include the preamble 410, the data field 420, and the postamble 430 as described with reference to FIG. 4. As described with reference to FIG. 4, the postamble 430 may or may not be included in a frame of the RD transmission 610. The data field 420 included in the frame of the RD transmission 610 may be a PRDCH. The PRDCH may include RD control information 611 as described earlier. The PRDCH may further include other necessary information in addition to the RD control information 611. The RD control information 611 included in the PRDCH may include, for example, control information for scheduling a DR transmission 620. In the exemplary embodiment of FIG. 6, a reference numeral 601 is used to indicate that the RD control information 611 is the control information for scheduling the DR transmission 620.

When the D node 320 receives the RD transmission 610, the D node 320 may transmit the DR transmission 620 to the R node 310 in response to the RD transmission 610 or based on the control information included in the RD transmission 610. In this case, the D node 320 may be in the on mode described above and may be in a state in which sufficient energy for transmitting the DR transmission 620 to the R node 310 is harvested from the CW node 330.

The D node 320 may transmit the DR transmission 620 to the R node 310 at a specific time. The DR transmission 620 may be transmitted within a time duration between T_R2D_min and T_R2D_max described above from an end time of the RD transmission 610. In other words, the DR transmission 620 may be transmitted within a time duration from a time at which T_R2D_min elapses from the end time of the RD transmission 610 to a time corresponding to T_R2D_max, which is indicated by a reference numeral 630. In the following description, the time duration indicated by the reference numeral 630 is referred to as a “DR transmission-possible time duration”.

According to an exemplary embodiment of the present disclosure, the DR transmission-possible time duration 630, which is a time duration from the time corresponding to T_R2D_min (i.e. T_R2D_min time) to the time corresponding to T_R2D_max (i.e. T_R2D_max time), may be set to be greater than one OFDM symbol length. In another exemplary embodiment, the DR transmission-possible time duration 630 may be defined (or set) as a length of a cyclic prefix (CP) of an OFDM symbol.

T_R2D_min and/or T_R2D_max described above may be values associated with a chip duration of the PRDCH. For example, T_R2D_min and/or T_R2D_max may be defined (or set) as an arbitrary multiple of an arbitrary chip duration among chip durations configurable in the PRDCH and/or PDRCH, or as a value obtained by adding a predetermined absolute time value to the arbitrary multiple.

In another example, T_R2D_min and/or T_R2D_max may be an arbitrary multiple of a chip duration configured in the PRDCH received by the D node 320, or a value obtained by adding a predetermined absolute time value to the arbitrary multiple.

In another example, T_R2D_min and/or T_R2D_max may be an arbitrary multiple of a chip duration of a PDRCH of the DR transmission to be transmitted by the D node 320, or a value obtained by adding a predetermined absolute time value to the arbitrary multiple.

In another example, when an information value related to T_R2D_min and/or T_R2D_max is included in the control information 611 of the PRDCH, T_R2D_min and/or T_R2D_max may be a value obtained by multiplying the information value with an arbitrary chip duration among chip durations configurable in the PRDCH and/or the PDRCH, or a value obtained by adding a predetermined absolute time value to the product of the two values.

In another example, when an information value related to T_R2D_min and/or T_R2D_max is included in the control information 611 of the PRDCH, T_R2D_min and/or T_R2D_max may be a value obtained by multiplying the information value with the chip duration configured in the PRDCH received by the D node 320, or a value obtained by adding a predetermined absolute time value to the product of the two values.

In another example, when an information value related to T_R2D_min and/or T_R2D_max is included in the control information 611 of the PRDCH, T_R2D_min and/or T_R2D_max may be a value obtained by multiplying the information value with the chip duration of the PDRCH of the DR transmission to be transmitted by the D node 320, or a value obtained by adding a predetermined absolute time value to the product of the two values.

In another example, T_R2D_min and/or T_R2D_max may be delivered from the R node 310 to the D node 320 through a higher-layer message (e.g. RRC message).

In another example, different values for T_R2D_min and/or T_R2D_max may be configured as a table and may be delivered from the R node 310 to the D node 320 through a higher-layer message (e.g. RRC message). Thereafter, the R node 310 may transmit, to the D node 320, information indicating values to be applied to the DR transmission in dynamic scheduling.

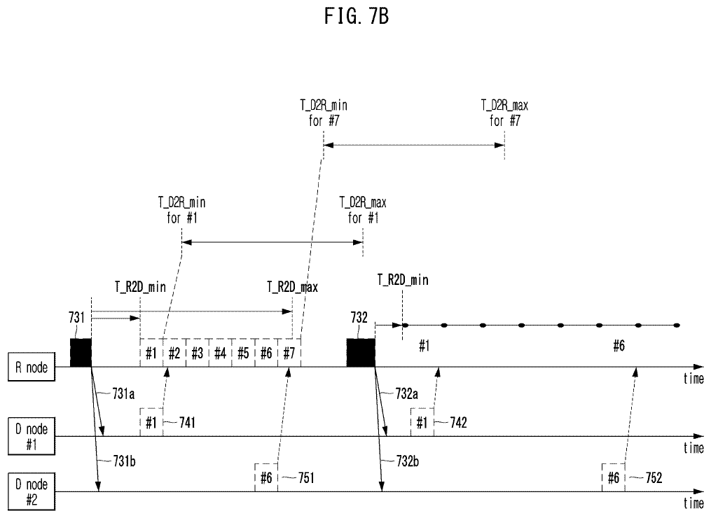

FIG. 7A is a conceptual diagram according to a first exemplary embodiment for determining a DR transmission time based on an RD transmission in an IoT system.

Referring to FIG. 7A, the R node 310 may transmit an RD transmission 710 to the D node 320. Therefore, the D node 320 may receive the RD transmission 710. The D node 320 may determine an end time of the RD transmission 710 based on one of the methods described above. When the D node 320 needs to perform a DR transmission in response to the RD transmission 710, as described above, the D node 320 may perform the DR transmission within a DR transmission-possible time duration 730 between the T_R2D_min time and the T_R2D_max time.

According to an exemplary embodiment of the present disclosure, the D node 320 may start the DR transmission according to a random count value. The random count value may indicate a number of IoT slots. The DR transmission scheme according to the present disclosure is defined as “random count transmission”. In addition, the IoT slots may indicate slots according to a slotted Aloha channel access scheme. A time length of the IoT slot may be a fixed time unit (or time value).

For example, the time length of the IoT slot may be the same time length as a time length of an OFDM symbol including CP.

In another example, the time length of the IoT slot may be the same time length as a time length of an arbitrary DR transmission. For example, when the arbitrary DR transmission is assumed to be a first message (message 1, Msg1) used in a random access procedure, the time length of the IoT slot may be the same time length as a time length of Msg1.

When determining the random count value or an initial random count value, the D node 320 may determine the random count value (or the initial random count value) to be within the DR transmission-possible time duration 730 between the T_R2D_min time and the T_R2D_max time. As illustrated in FIG. 7A, when the DR transmission-possible time duration 730 is configured with 7 IoT slots, the random count value (or the initial random count value) may be determined as one value among values equal to or greater than 1 and equal to or less than 7. In addition, the IoT slots may be identified by slot indexes #1, #2, #3, #4, #5, #6, and #7, respectively. The slot index #1 having the lowest slot index may start at the T_R2D_min time. In the example of FIG. 7A, a case is illustrated in which the slot index #7 having the highest slot index is allocated up to the T_R2D_max time. In other words, it may correspond to a case where the DR transmission-possible time duration is configured with 7 IoT slots. Therefore, when determining the random count value, the D node 320 may select a specific IoT slot for performing the DR transmission by selecting one IoT slot index among the IoT slots within the DR transmission-possible time duration 730.

The D node 320 may determine a DR transmission time by selecting the random count value within a range of the number of IoT slots of the DR transmission-possible time duration 730. In this case, the D node 320 may randomly select the random count value. A parameter indicating the range of the random count values may be set (or indicated) by one or both of an L1 parameter and an RRC message as a higher-layer message. Therefore, the D node 320 may select one of the random count values based on at least one of the L1 parameter and the RRC message.

FIG. 7B is a conceptual diagram according to a second exemplary embodiment for determining a DR transmission time based on an RD transmission in an IoT system.

In FIG. 7B, the R node may transmit one RD transmission 731 to two different D nodes as illustrated by reference numerals 731a and 731b. According to the exemplary embodiment of FIG. 7B, the RD transmission 731 from the R node to a D node #1 is illustrated by the reference numeral 731a, and the RD transmission 731 from the R node to a D node #2 is illustrated by the reference numeral 731b. The RD transmission 731 may include RD control information (not illustrated in FIG. 7B) as described with reference to FIG. 6. The RD control information may include a trigger message for instructing the D nodes to perform random access procedures to the R node. In FIG. 7B, a case is illustrated in which the RD transmission 731 is transmitted to two D nodes, but the trigger message instructing the D node(s) to perform the random access procedures may also be broadcast to the D node(s).

Each of the D nodes that receive the trigger message from the R node may transmit a DR transmission 741 or 751 to the R node in response to the RD transmission 731. Each of the D nodes may transmit the DR transmission to the R node in a DR transmission-possible time duration between the T_R2D_min time and the T_R2D_max time. Here, T_R2D_min and T_R2D_max may be values defined by the technical specifications, values received when communicating with the R node at a previous time, or values set at manufacturing according to characteristics of the D node.

As described in FIG. 7A, the D node may divide the DR transmission-possible time duration into constant time durations. The D node may select one of the divided time durations as a time duration for the DR transmission. As described in FIG. 7A, one unit-time duration may be an IoT slot. As a method for selecting one time duration, the method described in FIG. 7A may be used. In other words, each of the D nodes may divide the DR transmission-possible time duration into IoT slots, may generate a random number within a number of the divided IoT slots, and may perform the DR transmission in an IoT slot corresponding to the generated number.

In this case, a length of the IoT slot may be assumed as a length of a specific DR transmission. For example, the length of the IoT slot may be a time length equal to a time length of Msg1 in a random access procedure. In another example, the length of the IoT slot may be an arbitrary specific time length irrelevant to Msg1. When the length of the IoT slot is an arbitrary specific time length irrelevant to Msg1, the time length may be determined by the technical specifications or may be configured in the D node(s) by the R node through a higher-layer message. The IoT slots may be identified by slot indexes #1, #2, #3, #4, #5, #6, and #7.

Among the IoT slot indexes, the slot index #1 that is the lowest slot index may start from the T_R2D_min time. The slot index #7 that is the highest slot index may be allocated up to the T_R2D_max time. FIG. 7B illustrates an exemplary case where the DR transmission-possible time duration is composed of 7 IoT slots.

Each of the D nodes may randomly select a position of an IoT slot for the DR transmission within the DR transmission-possible time duration between the T_R2D_min time and the T_R2D_max time, and may start the DR transmission in the selected IoT slot. In another example, each of the D nodes may start the DR transmission in an IoT slot selected according to transmission conditions among the IoT slots within the DR transmission-possible time duration between the T_R2D_min time and the T_R2D_max time.

According to the example of FIG. 7B, a D node #1 may select the IoT slot index #1 as an IoT slot for Msg1 transmission in response to the RD transmission 731 including the trigger message. Therefore, the D node #1 may transmit the DR transmission 741 including Msg1 to the R node in the IoT slot index #1. The Msg1 described in FIG. 7B is a DR transmission. However, since the Msg1 is the first message in the random access procedure, the frame may be configured only with a portion of the structure in FIG. 4.

For example, the Msg1 may not include the preamble 410 and the postamble 430. In other words, the Msg1 may include only the data field 420. A reason for configuring the Msg1 in such a manner is that the R node already triggers the random access procedure and the Msg1 transmitted by the D node to the R node in the random access procedure may be configured with a specific sequence. Therefore, even when the preamble 410 and the postamble 430 are not included in the Msg1, the R node may detect the sequence of the Msg1.

In another example, the Msg1 may include only the preamble 410 and the data field 420. In this case, the data field 420 may include only a specific sequence used for the Msg1 in the random access procedure. In addition, the preamble 410 may be used for detecting the DR transmission, and thus only the preamble 410 and the specific sequence of the Msg1 may be configured to be transmitted.

In still another example, the Msg1 may be configured only with the data field 420 and the postamble 430. In this case, the data field 420 may include only a specific sequence used for the Msg1 in the random access procedure. Since the R node triggers the random access procedure, the R node may detect the Msg1 without detecting the preamble 410. In this case, the postamble 430 may be used for detecting an end of the preamble.

A D node #2 may select the IoT slot index #6 as an IoT slot for Msg1 transmission in response to the RD transmission 731 including the trigger message in the same manner as the D node #1.

The D node #1 may transmit the DR transmission 741 including the Msg1 to the R node in the IoT slot index #1, and the D node #2 may transmit the DR transmission 751 including the Msg1 to the R node in the IoT slot index #6.

FIG. 7B illustrates a case where the D node #1 and the D node #2 select different IoT slot indexes. When the D node #1 and the D node #2 select an identical IoT slot index, a collision between the Msg1 transmitted by the D node #1 and the Msg1 transmitted by the D node #2 may occur. When such collision of Msg1 occurs, transmission of the trigger message may start again. The R node may receive the DR transmissions 741 and 751 from different D nodes. The R node may identify IoT slot index numbers at which the DR transmissions 741 and 751 from the D nodes are received. The IoT slot index number may be transmitted together with the Msg1 by each of the D nodes or may be identified by the R node by calculating the number of IoT slots and counting the IoT slots in which the received Msg1 is transmitted.

The R node may transmit a single RD transmission 732 including Msg2 to the D nodes in response to the DR transmissions 741 and 751 received from the D nodes. In FIG. 7B, the RD transmission 732 from the R node to the D node #1 is illustrated as a reference numeral 732a, and the RD transmission 732 from the R node to the D node #2 is illustrated as a reference numeral 732b.

A transmission time of the Msg2 responding to the Msg1 may be determined based on T_D2R_min set based on the IoT slot index #1, T_D2R_max set based on the IoT slot index #1, T_D2R_min set based on the IoT slot index #7, and T_D2R_max set based on the IoT slot index #7. As described above, T_D2R_min may start from an end time of a specific IoT slot, and T_D2R_max may be a value configured in the D node by the R node, a value defined by the technical specifications, or a value set at manufacturing according to characteristics of the D node. As illustrated in FIG. 7B, the RD transmission 732 including the Msg2 may be transmitted within a time duration from a time after T_D2R_min for the IoT slot index #7 to a time of T_D2R_max for the IoT slot index #1. In the present disclosure, a time duration in which the RD transmission responding to the DR transmission is transmittable based on IoT slot indexes is referred to as an ‘RD transmission-possible time duration’.

The R node may transmit the RD transmission 732 (i.e. 732a and 732b) including the Msg2 to the D nodes in the RD transmission-possible time duration. In this case, the RD transmission 732 may include RD control information or the Msg2 itself may be RD control information.

In general, the Msg1 may be configured with a specific sequence for random access, and a length of the specific sequence may be very short. In contrast, the Msg3 may include an RRC connection request and identification information of the D node, and thus the Msg3 may have a relatively larger size than the Msg1. Therefore, the Msg3 may require transmission of more data than the Msg1. Therefore, a time resource longer than a time-unit of an OFDM symbol including CP, which is a transmission time length of the Msg1 described above, or a time resource longer than the transmission time length of Msg1 may need to be allocated. Therefore, the RD control information included in the RD transmission 732 or the Msg2 itself may include resource information for the Msg3. The resource information for the Msg3 may be understood as information on a resource in which transmission of the Msg3 is possible when communication is performed between one R node and two or more D nodes as illustrated in FIG. 7B.

The RD control information included in the RD transmission 732 or the Msg2 itself may include Msg3 transmission resource information configured to include a number of slots for transmission of the Msg3 identical to a number of IoT slots in which Msg1 is transmittable. For example, when the number of IoT slots for transmitting the Msg1 by each of the D nodes is 7, the resource information of the Msg3 may be configured with 7 slots for transmission of the Msg3. In this case, the IoT slot for transmitting the Msg1 and the IoT slot for transmitting the Msg3 may have the same slot length or may have different slot lengths. The example of FIG. 7B may assume different slot lengths for the IoT slot for transmitting the Msg1 and the IoT slot for transmitting the Msg3.

As illustrated in FIG. 7B, when the R node receives the Msg1s from two or more different D nodes, the R node may transmit the Msg2 including two or more different IoT slot indexes to the D nodes.

Each of the D nodes may recognize the RD transmission-possible time duration based on the number of IoT slots and values of T_R2D_min and T_R2D_max. More specifically, each of the D nodes may recognize the RD transmission-possible time duration based on T_D2R_min for the IoT slot index #7 and T_D2R_max for the IoT slot index #1.

Therefore, each of the D nodes that transmit the Msg1 may attempt to receive the Msg2 in the RD transmission-possible time duration. The D node #1 may receive the RD transmission 732a from the R node in the RD transmission-possible time duration, and the D node #2 may also receive the RD transmission 732b from the R node in the RD transmission-possible time duration.

Each of the D nodes that receive the Msg2 may identify, based on the Msg2, whether the Msg1 transmitted by itself is normally received at the R node. A method for identifying whether the Msg1 transmitted by the D node is normally received at the R node may be as follows.

First, each of the D nodes that transmit the Msg1 may recognize an IoT slot index in which the Msg1 is transmitted. Therefore, each of the D nodes may recognize that the Msg1 is normally transmitted when the IoT slot index in which the Msg1 is transmitted is included in the received Msg2. Therefore, the D node may determine that Msg3 transmission is permitted when the IoT slot index in which the Msg1 is transmitted is included in the Msg2.

Each of the D nodes that receive the Msg2 may transmit the Msg3 based on Msg3 transmission resource information at a time after T_R2D_min. The Msg3 transmission resource information may indicate a resource in which the Msg3 is transmittable. The D nodes that transmit the Msg3 may be the D nodes whose IoT slot indexes corresponding to the DR transmission including the Msg1 are included in the Msg2 received from the R node.

Here, the IoT slot index (or value) used in the DR transmission 741 or 751 including the Msg1 may be utilized in an RD transmission associated with the DR transmission or in another DR transmission associated with the DR transmission. For example, the IoT slot index selected by the D node to transmit the Msg1 in the random access procedure may be included in the Msg2 transmitted by the R node to the D node in response to reception of the Msg1. Therefore, the D node that receives the Msg2 may identify the IoT slot index included in the Msg2 and may recognize that the R node receives the Msg1 transmitted by the D node.

The D node #1 may transmit the DR transmission 742 including the Msg3 in a slot index (i.e. slot index #1) identical to the IoT slot index (i.e. IoT slot index #1) in which the Msg1 is transmitted. In the same manner, the D node #2 may transmit the DR transmission 752 including the Msg3 in a slot index (i.e. slot index #6) identical to the IoT slot index (i.e. IoT slot index #6) in which the Msg1 is transmitted.

The slots respectively allocated to the DR transmissions 742 and 752 in which the D node #1 and D node #2 transmit the Msg3 may be slots based on the resource information configured in the RD transmission 732 in which the Msg2 is transmitted. FIG. 7B illustrates an exemplary case where a size of the slot in which the Msg1 is transmitted and a size of the slot in which the Msg3 is transmitted are configured differently.

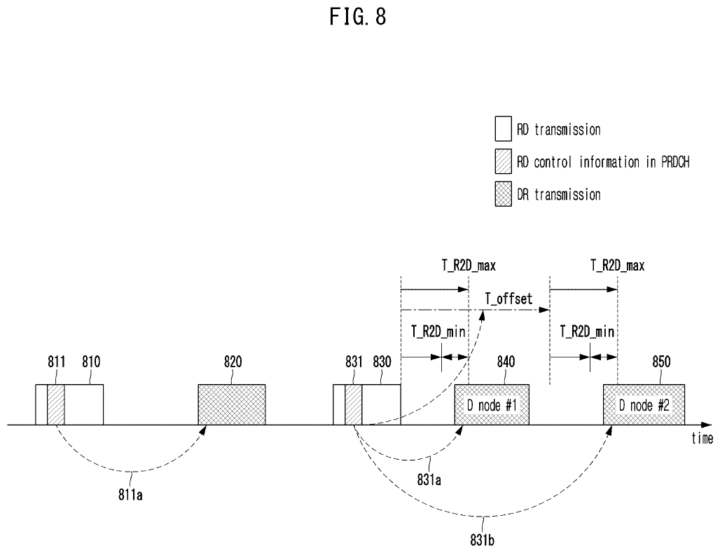

FIG. 8 is a conceptual diagram illustrating a first exemplary embodiment in which an R node instructs two or more D nodes to perform DR transmissions in an IoT system.

Referring to FIG. 8, when the R node transmits an RD transmission 810 to one D node, the RD transmission 810 may transmit control information and/or data through a PRDCH as described above. In the PRDCH, RD control information 811 may include scheduling information for a DR transmission to a specific D node, as described in FIG. 6. In FIG. 8, the RD control information 811 included in the PRDCH of the RD transmission 810 transmitted from the R node to the D node is illustrated by a reference numeral 811a in order to indicate that the RD control information 811 is control information for scheduling a DR transmission 820.

Meanwhile, as described in FIG. 7B, the R node may schedule DR transmissions of two or more D nodes by using the single RD transmission 830. As illustrated in FIG. 8, the R node may transmit the single RD transmission 830 to the D node #1 and the D node #2. Therefore, the D node #1 and the D node #2 may receive the RD transmission 830 from the R node.

The RD transmission 830 may have a frame structure identical to that described in FIG. 4. The data field 420 illustrated in FIG. 4 may be understood as a PRDCH as described in FIG. 6. The PRDCH may include RD control information 831. The RD control information 831 in the PRDCH may include scheduling information for a DR transmission 840 of the D node #1 and scheduling information for a DR transmission 850 of the D node #2. Therefore, each of the D node #1 and the D node #2 may transmit the DR transmission 840 or 850 to the R node based on the RD control information 831 in the PRDCH.

The R node may configure or indicate a time offset T_offset in one or both of the scheduling information for the D node #1 and the scheduling information for the D node #2. In the following description, the time offset T_offset is assumed as one offset value used when the D node receiving the RD transmission calculates a start time of the DR transmission.

In the exemplary embodiment of FIG. 8, when the time offsets are configured in both the scheduling information for the D node #1 and the scheduling information for the D node #2, the time offset configured for the D node #1 may be zero. When the time offset is configured in one of the scheduling information for the D node #1 and the scheduling information for the D node #2, the time offset may be configured in the scheduling information for the D node #2.

The time offset may be set as a constant time value from an end time of the RD transmission 830 as illustrated in FIG. 8. The time offset T_offset may be a time value used to set the end time of the actual RD transmission 830 to a time delayed by T_offset. The time offset may be included in L1 control information or in a higher-layer message (e.g. RRC message) and may be delivered to the D node #1 and the D node #2.

Therefore, the D node #1, for which the time offset is not configured or the time offset is configured as zero, may transmit the DR transmission 840 to the R node based on the RD control information 831 included in the RD transmission 830. In this case, the DR transmission may start in a DR transmission-possible time duration from the T_R2D_min time to the T_R2D_max time, as described above.

On the other hand, the D node #2, for which the time offset is not zero, may transmit the DR transmission 850 to the R node based on the scheduling information for the D node #2 included in the RD control information 831 of the RD transmission 830 and based on the time offset. As described above, since the time offset is a time value for setting the end time of the RD transmission 830 as a time delayed by T_offset from the actual end time of the RD transmission 830, the D node #2 may reconfigure T_R2D_min and T_R2D_max based on the time offset. As described above, the D node #2 may transmit the DR transmission 850 to the R node in a DR transmission-possible time duration based on T_R2D_min and T_R2D_max reconfigured based on the time offset.

In the example of FIG. 8, the DR transmission-possible time duration corresponding to a time duration between the T_R2D_min time and the T_R2D_max time may be predefined by the technical specifications or may be preconfigured through a higher-layer message (e.g. RRC message).

In another exemplary embodiment, two or more different DR transmission times may be indicated by the R node to the D nodes with reference to an end time of one RD transmission. The two or more different DR transmission times may be mapped to the D nodes, respectively. When the R node knows identifiers of the D nodes, the different DR transmission times may be mapped to the identifiers of the D nodes, respectively. When the R node does not know identifiers of the D nodes (e.g. when Msg3 transmission is indicated as illustrated in FIG. 7B), the two or more different DR transmission times may be mapped, respectively, to IoT slot indexes corresponding to the respective D nodes.

Hereinafter, for convenience of description, a case where the R node instructs two D nodes to perform DR transmissions is assumed. The two D nodes are assumed as the D node #1 and the D node #2 described in FIG. 8.

The R node may configure time offsets indicating start times of two DR transmission resources to be transmitted by the two D nodes (i.e. D node #1 and D node #2) in RD control information within an RD transmission. Among the two time offsets, the first time offset may be a time offset indicating a start time of the first DR transmission resource. Here, the first DR transmission resource is assumed as a transmission resource of the DR transmission transmitted by the D node #1.

In other words, the R node may configure a start time of the DR transmission corresponding to (or responding to) the RD transmission to the D node #1 by using the first time offset included in the RD control information. The start time at which the D node #1 transmits the DR transmission may refer to a time difference from an end time of the RD transmission to the start time of the DR transmission. Here, a value of the time difference may be an absolute time value or may be a value that can be calculated or derived based on information on a chip duration of the RD transmission or DR transmission.

The second offset among the time offsets may mean a time difference from a start time of the transmission resource of the first DR transmission transmitted by the D node #1 to a start time of the second DR transmission. The time difference may be an absolute time value or may be a value that is calculated or derived based on information on the chip duration of the RD transmission or DR transmission.

The first time offset and the second time offset may be configured for each RD transmission transmitted by the R node, or may be values preconfigured when the D nodes perform a random access procedure.

In another example, the first time offset may be a value configured for each RD transmission transmitted by the R node, and the second time offset may be a value configured for the D node #2 when the D node #2 performs a random access procedure.

In still another example, the first time offset may be a value configured for the D node #1 when the D node #1 performs a random access procedure, and the second time offset may be a value configured for each RD transmission transmitted by the R node.

In the exemplary embodiments above, one of the two values has been described as a value configured during the random access procedure, but the value may be configured by an RRC configuration message or an RRC reconfiguration message.

The D node #1 may start the DR transmission based on the first time offset among the two time offsets received from the R node. In addition, the D node #2 may start the DR transmission by using both of the two time offsets received from the R node.

When the D node #2 determines a start time of the DR transmission, the D node #2 may calculate (or derive) the start time of the transmission resource for the first DR transmission by applying the first time offset to the end time of the RD transmission. The D node #2 may calculate (or derive) a start time of a transmission resource for the DR transmission to be transmitted by the D node #2 based on the calculated (or derived) start time of the first DR transmission and the second time offset.

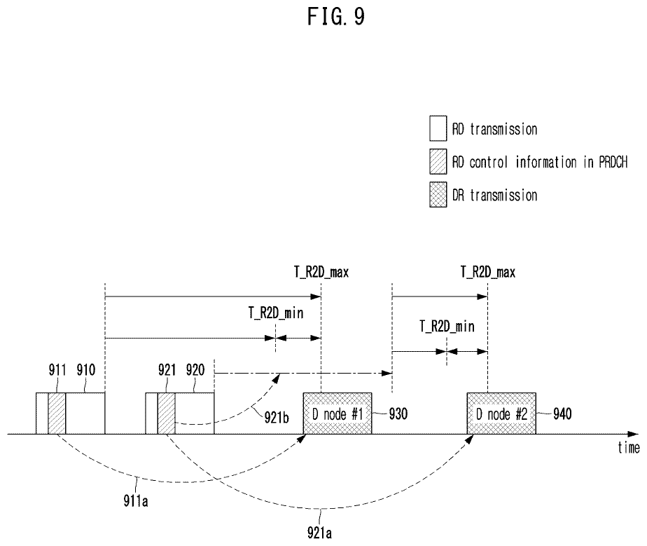

FIG. 9 is a conceptual diagram illustrating a second exemplary embodiment in which an R node instructs two or more D nodes to perform DR transmissions in an IoT system.

Referring to FIG. 9, the R node may transmit RD transmissions 910 and 920 respectively to two different D nodes. Hereinafter, for distinguishing the two different D nodes, the two different D nodes are assumed as the D node #1 and the D node #2.

The R node may first transmit the RD transmission 910 to the D node #1 and may transmit the RD transmission 920 to the D node #2 after a predetermined time. In this case, since the RD transmissions 910 and 920 are RD transmissions to different D nodes, a time interval between the RD transmission 910 to the D node #1 and the RD transmission 920 to the D node #2 may be set to a value different from a time interval defined by T_R2R_min and T_R2R_max which define a time interval between continuous RD transmissions to one D node. For example, the time interval between the RD transmission 910 to the D node #1 and the RD transmission 920 to the D node #2 may have a time interval predefined by the technical specifications. As an extreme example, the time interval between the RD transmission 910 to the D node #1 and the RD transmission 920 to the D node #2 may be zero. In other words, the RD transmission 910 to the D node #1 and the RD transmission 920 to the D node #2 may be transmitted in continuous slots.

When the R node transmits the RD transmission 910 to the D node #1, the RD transmission 910 may transmit control information and/or data through a PRDCH as described above. In the PRDCH, RD control information 911 may include scheduling information for a DR transmission to a specific D node, as described in FIG. 6. In FIG. 9, the RD control information 911 included in the PRDCH of the RD transmission 910 transmitted by the R node to the D node #1 is illustrated by a reference numeral 911a in order to indicate that the RD control information 911 is control information for scheduling a DR transmission 930.

The R node may transmit the RD transmission 920 to the D node #2 after a predetermined time from the RD transmission 910 to the D node #1 or consecutively after the RD transmission 910 to the D node #1. The RD transmission 920 to the D node #2 may also transmit control information and/or data through a PRDCH. In the PRDCH, RD control information 921 may include scheduling information for a DR transmission to the D node #2. In FIG. 9, the RD control information 921 included in the PRDCH of the RD transmission 920 transmitted by the R node to the D node #2 is illustrated by a reference numeral 921a in order to indicate that the RD control information 921 is control information for scheduling a DR transmission 940.

T_R2D_min and T_R2D_max, which define a time interval between an RD transmission for indicating a DR transmission and the DR transmission according to scheduling of the RD transmission from the R node, may be values defined by the technical specifications or may be configured through a higher-layer message (e.g. RRC message).

The D node #1 may receive the RD transmission 910 from the R node and may identify scheduling information for the DR transmission based on the RD control information 911 included in the RD transmission 910. In addition, the D node #2 may receive the RD transmission 920 from the R node and may identify scheduling information for the DR transmission based on the RD control information 921 included in the RD transmission 920.

The RD control information 911 including scheduling information for the D node #1 and the RD control information 921 including scheduling information for the D node #2 may include information related to a start time of the DR transmission. The information related to the DR transmission may include, for example, T_R2D, which is time information as L1 control information indicating the DR transmission after the RD transmission.

T_R2D may be configured as a specific value and may be a value greater than or equal to T_R2D_min, as described in FIG. 5A. In addition, T_R2D may be a value smaller than T_R2D_max. Therefore, the D node #1 and the D node #2 may respectively start DR transmissions based on the RD control information 911 and the RD control information 921.

When a time offset is included in one or more of the RD control information 911 and the RD control information 921, the time offset may set an end time of the RD transmission as a time delayed by the time offset. In other words, T_R2D_min and T_R2D_max may be values calculated based on a time that is delayed from the end time of the RD transmission by the time offset. In the present disclosure, a case where both the RD control information 911 and the RD control information 921 include time offsets is assumed.

The D node #1, which receives the RD transmission 910 from the R node, may determine a DR transmission time based on the RD control information 911. The RD control information 911 may include T_R2D and the time offset as described above. In the example of FIG. 9, the time offset included in the RD control information 911 may be assumed as zero.

Therefore, the D node #1 may transmit the DR transmission 930 to the R node based on T_R2D included in the RD control information 911. As described above, T_R2D may indicate a time (or, a slot or a transmission time unit) after T_R2D_min and before T_R2D_max.

In addition, the D node #2, which receives the RD transmission 920 from the R node, may determine a DR transmission time based on the RD control information 921. The RD control information 921 may also include T_R2D and a time offset. In the example of FIG. 9, the time offset included in the RD control information 921 may have a value indicated by a reference numeral 921b. Such a time offset may be configured as a value in which the DR transmission of the D node #1 is taken into account. Therefore, the D node #2 may transmit the DR transmission 940 to the R node based on T_R2D included in the RD control information 921 at a time after the time offset. T_R2D included in the RD control information 921 may also indicate a time (or, a slot or a transmission time unit) after T_R2D_min and before T_R2D_max.

When T_R2D is 0, T_R2D_min and/or T_R2D_max may be the same as a time after the end time of the RD transmission.

### T_r2d Configuration (calculation) Methods

Meanwhile, RD control information included in a PRDCH may not include or configure T_R2D. When the RD control information does not include or configure T_R2D, the D node may assume that T_R2D is 0. In another example, when RD control information does not include or configure T_R2D, the D node may start a DR transmission at a time (or, a slot or a transmission time unit) between the T_R2D_min time and the T_R2D_max time after a time at which the RD transmission of the PRDCH ends. Here, the time at which the RD transmission ends may be a time at which the postamble 430 ends, a time at which an OFDM symbol including valid OOK symbol(s) of the PRDCH ends, or a time at which the D node determines the end of the RD transmission from L1 control information related to the PRDCH configuration, as described above. In an exemplary embodiment, T_R2D may be defined as one of a number of clocks based on a predefined clock after the RD transmission, a multiple of a chip time, an IoT slot value, or an absolute time value.

In another exemplary embodiment, T_R2D may be defined as a value obtained by calculating the time offset T_offset in association with a chip duration of the PRDCH. For example, a multiple multiplied by a chip duration among chip durations configurable in the PRDCH may be defined as T_R2D. In this case, the D node may calculate a value obtained by multiplying an arbitrary chip duration with T_R2D included in the control information. Thereafter, the D node may perform a calculation by further considering the time offset T_offset in the product of the chip duration and T_R2D. The time offset may be a value of the product of the chip duration and T_R2D itself, a value obtained by adding a certain absolute time value to the product of the chip duration and T_R2D, or a value obtained by adding T_R2D_min to the product of the chip duration and T_R2D.

In another exemplary embodiment, the time offset may be calculated by including a value obtained by multiplying a specific value with the chip duration configured in the PRDCH received by the D node. The specific value may be T_R2D included in the RD control information. In this case, the time offset may be a product of T_R2D and the chip duration configured in the PRDCH received by the D node, or may be a value obtained by adding a certain absolute time value to the product of the two values, or may be a value obtained by adding T_R2D_min to the product of the two values.

In yet another exemplary embodiment, a chip duration of a DR transmission to be transmitted by the D node may be used instead of the chip duration configured in the PRDCH received by the D node in the above exemplary embodiment. In other words, the D node may calculate the time offset by including a value obtained by multiplying T_R2D included in the RD control information of the PRDCH that schedules the DR transmission with the chip duration of the PDRCH indicated or configured through the RD control information. Based on such a calculation, the time offset may be the product of the two values, or may be a value obtained by adding a certain absolute time value to the product of the two values, or may be a value obtained by adding T_R2D_min to the product of the two values.

In the exemplary embodiments described above, the R node may deliver information or a value of T_R2D to the D node by including the information or value of T_R2D in the RD control information included in PRDCH. The D node may receive the PRDCH and may calculate the time offset by using the information on T_R2D included in the received PRDCH and the chip duration. The D node may start the DR transmission at a time indicated by T_R2D from the end time of the RD transmission including the indicated T_R2D. T_R2D may be configured differently for each D node.

Hereinafter, the time offset T_offset, the minimum time value T_R2D_min for the DR transmission in response to the RD transmission, and the maximum time value T_R2D_max for the DR transmission in response to the RD transmission may be calculated from the chip duration as follows.

The time offset T_offset may be calculated as a value obtained by multiplying T_R2D included in the RD control information, which indicates a DR transmission start time, with the chip duration of the PRDCH including the RD control information. One of T_R2D_min or T_R2D_max may be calculated as a value obtained by multiplying T_R2D included in the RD control information with the chip duration of the PDRCH that is scheduled by the RD control information.

The minimum time interval T_D2R_min and/or the maximum time interval T_D2R_max between RD transmissions to be transmitted by the R node to the D node in response to (or corresponding to) the DR transmission from the D node to the R node may be calculated as follows.

T_D2R_min and/or T_D2R_max may be an arbitrary multiple of an arbitrary chip duration among chip durations configurable in the PRDCH and/or the PDRCH, or may be a value obtained by adding an absolute time to an arbitrary multiple of an arbitrary chip duration among chip durations configurable in the PRDCH and/or the PDRCH.

In another exemplary embodiment, T_D2R_min and/or T_D2R_max may be an arbitrary multiple of the chip duration configured in the PRDCH including the RD control information that schedules the DR transmission to be transmitted by the D node, or may be a value obtained by adding an arbitrary absolute time to an arbitrary multiple of the chip duration configured in the PRDCH including the RD control information that schedules the DR transmission to be transmitted by the D node.

In yet another exemplary embodiment, T_D2R_min and/or T_D2R_max may be an arbitrary multiple of the chip duration of the PDRCH of the DR transmission to be transmitted by the D node, or may be a value obtained by adding an arbitrary absolute time to an arbitrary multiple of the chip duration of the PDRCH of the DR transmission to be transmitted by the D node.

In yet another exemplary embodiment, when the RD control information that schedules the DR transmission to be transmitted by the D node includes an information value relating to T_D2R_min and/or T_D2R_max, T_D2R_min and/or T_D2R_max may be a value obtained by multiplying the indicated T_D2R_min and/or T_D2R_max with an arbitrary chip duration among chip durations configurable in the PRDCH and/or the PDRCH, or may be a value obtained by adding an arbitrary absolute time to a value obtained by multiplying T_D2R_min and/or T_D2R_max with an arbitrary chip duration among chip durations configurable in the PRDCH and/or the PDRCH.

In yet another exemplary embodiment, when the RD control information that schedules the DR transmission to be transmitted by the D node includes an information value relating to T_D2R_min and/or T_D2R_max, T_D2R_min and/or T_D2R_max may be a value obtained by multiplying the indicated T_D2R_min and/or T_D2R_max with the chip duration configured in the PRDCH including the RD control information, or may be a value obtained by adding an arbitrary absolute time to the value obtained by multiplying the indicated T_D2R_min and/or T_D2R_max with the chip duration configured in the PRDCH including the RD control information.

In yet another exemplary embodiment, when the RD control information that schedules the DR transmission to be transmitted by the D node includes T_D2R_min and/or T_D2R_max, T_D2R_min and/or T_D2R_max may be a value obtained by multiplying the indicated T_D2R_min and/or T_D2R_max with the chip duration of the PDRCH of the DR transmission to be transmitted by the D node, or may be a value obtained by adding an arbitrary absolute time to a value obtained by multiplying the indicated T_D2R_min and/or T_D2R_max with the chip duration of the PDRCH of the DR transmission to be transmitted by the D node.

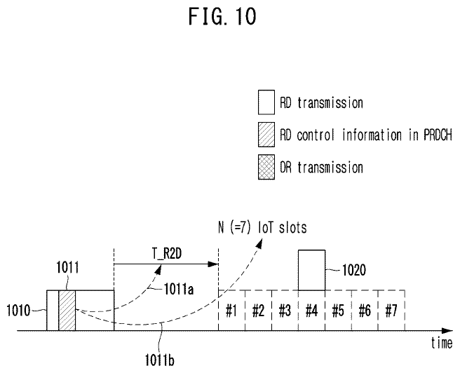

FIG. 10 is a conceptual diagram illustrating an exemplary embodiment of a configuration of T_R2D in an IoT system.

FIG. 10 illustrates another exemplary embodiment of the T_R2D configuration (calculation) method described above. Referring to FIG. 10, the R node may transmit an RD transmission 1010 to the D node. The RD transmission 1010 may be configured in a form including at least a part of the frame structure described in FIG. 4 above. The RD transmission 1010 may include RD control information 1011 within a PRDCH that constitutes the data field 420. The RD control information 1011 may include scheduling information for transmitting a DR transmission 1020. The scheduling information included in the RD control information 1011 may include T_R2D. T_R2D may be defined as a start time of a random count for the DR transmission 1020. The random count may indicate a number of IoT slots. In addition, the R node may further include, in the RD control information 1011, a number N of candidate IoT slots for the DR transmission in addition to T_R2D. In the exemplary illustration of FIG. 10, the number N of candidate IoT slots may be assumed to be 7.

The D node may receive the RD transmission 1010 from the R node. The D node may identify the scheduling information for the DR transmission from the RD control information 1011 of the received RD transmission 1010. The scheduling information for the DR transmission may include T_R2D. The D node may randomly select a specific value. In this case, a range of values that may be randomly selected may be one of values within the number N of candidate IoT slots included in the RD control information 1011. As illustrated in FIG. 7, when the number N of candidate IoT slots is 7, the randomly selected value may be a natural number among 1 to 7.

In FIG. 10, a form in which slot indexes are assigned to the IoT slots from a time based on T_R2D is illustrated, and the value randomly selected by the D node may be 4. Therefore, the D node may assign slot indexes to 7 IoT slots based on the number N of candidate IoT slots from the time derived from T_R2D, as illustrated in FIG. 10. In other words, the D node may set an IoT slot index that starts at the time based on T_R2D as slot index #1, and may assign slot index #2, slot index #3, slot index #4, slot index #5, slot index #6, and slot index #7 to respective subsequent consecutive slots.

When the value randomly selected by the D node is 4, the D node may calculate the T_R2D time from an end time of the RD transmission, and may start the DR transmission 1020 in slot index #4 among the IoT slots.

For example, a length of an IoT slot may be a length of an OFDM symbol including CP. In another example, a length of an IoT slot may be assumed as a length of a specific DR transmission (e.g. well-known message such as Msg1 or Msg3).

T_R2D may be determined differently from the exemplary embodiment illustrated in FIG. 10. According to an exemplary embodiment, when the R node communicates with two or more D nodes, T_R2D may be a unit time difference for determining a DR transmission time offset according to a DR transmission order of different D nodes. For example, T_R2D may be equal to T_R2D_max. In another example, T_R2D may be a predefined value. In yet another example, T_R2D may be a value configured by the R node to the D node through a higher-layer message (e.g. RRC message).

A case where the R node schedules DR transmissions for three different D nodes is assumed.

When the R node schedules three different DR transmissions, according to a first exemplary embodiment, the R node may deliver the address values to the D nodes through an RD transmission by sequentially including the address values (e.g. IDs) of three different D nodes in L1 control information or PRDCH data. Each of the D nodes that receive the sequentially configured address values may recognize a corresponding order.

Each of the D nodes that receive the RD transmission may transmit a DR transmission to the R node by considering an ID order and T_R2D indicated by the RD control information. Assuming that the three D nodes are referred to as D node #1, D node #2, and D node #3, and that corresponding orders are D node #1, D node #2, and D node #3, the operation may be performed as follows.

The D node #1 may perform the DR transmission after the T_R2D_min time when transmission within a time duration is assumed.

The D node #2 may perform the DR transmission by further considering T_R2D. In other words, since the D node #2 performs the DR transmission after the DR transmission of the D node #1, the D node #2 may perform the DR transmission by further considering T_R2D_min considered by the D node #1 and T_R2D for the DR transmission of the D node #2.

The D node #3 may perform the DR transmission by further considering a time corresponding to two times T_R2D. In other words, since the D node #3 performs the DR transmission after the DR transmission of the D node #1 and the DR transmission of the D node #2, the D node #3 may perform the DR transmission by further considering T_R2D_min considered by the D node #1 when performing the DR transmission, T_R2D considered by the D node #2 when performing the DR transmission, and T_R2D for the DR transmission of the D node #3.

According to the method described above, when the R node communicates with a plurality of D nodes, an n-th D node may perform its DR transmission by considering ‘T_R2D_min+T_R2D×(n−1)’ when transmitting the DR transmission.

When the R node schedules three different DR transmissions, according to a second exemplary embodiment, the R node may perform an RD transmission by including, as L1 control information or PRDCH data, scheduling information for DR transmissions in the RD control information, wherein the scheduling information includes ordering information for each D node. Therefore, each of the D nodes may perform the DR transmission based on the order of the D node included in the L1 control information or PRDCH data. In this case, an n-th D node may perform its DR transmission by considering ‘T_R2D_min+T_R2D×(n−1)’ when transmitting the DR transmission.

### PRDCH L1 Control Information

A D node may determine a ‘DR transmission condition’ according to a ‘reception D node designation condition’ included in L1 control information. The reception D node designation condition may indicate that the address of the reception D node is designated as a single D node, a D node group, and/or a broadcast.

The DR transmission condition may indicate at least one of ‘in-duration transmission’, ‘random count transmission’, or ‘combined transmission (i.e. which is a combination of ‘in-duration transmission’ and ‘random count transmission’)’.

For example, when a single D node address (ID) is indicated in the L1 control information, the D node may perform the DR transmission according to ‘in-duration transmission’.

In another example, when a condition in which one or more D nodes need to perform DR transmissions is indicated through a group ID or a broadcast, the D node may perform the DR transmission according to ‘random count transmission’.

### Reception Time Delivery According to Energy Harvesting State

A D node may lack energy to receive an RD transmission up to a certain time because harvested energy is consumed for a DR transmission. An R node may start the RD transmission corresponding to the DR transmission by considering an energy consumption state of the D node. For example, the R node may start the RD transmission within a time duration between the T_D2R_min time and the T_D2R_max time. Here, T_D2R_min and/or T_D2R_max may be differently set for each D node.

In another example, when D nodes connected to the same network or the same R node are configured with the same T_D2R_min and/or T_D2R_max, a time offset may be differently set for each of the D nodes. To distinguish from the time offset T_offset for the DR transmission of the D node described above in the exemplary embodiment of the reception time according to the energy harvesting state, the time offset of the R node is referred to as a second time offset T_offset2. The second time offset may be a time offset for the R node to perform the RD transmission based on the DR transmission that the R node receives from the D node.

The R node may perform the RD transmission for a D node for which the second time offset is set. The fact that the second time offset is set may indicate that the D node confirms information regarding the time at which the D node can receive the RD transmission. The R node may perform the RD transmission by considering the second time offset. More specifically, the R node may start the RD transmission within a time duration between a time corresponding to ‘T_D2R_min+T_offset2’ and a time corresponding to ‘T_D2R_max+T_offset2’. Information for the second time offset, calculation of the second time offset, or determination of the second time offset may be delivered by the R node to the D node through a higher-layer message (e.g. RRC message).

The D node may transmit the second time offset to the R node based on the information for the second time offset, calculation of the second time offset, or determination of the second time offset. For example, the D node may transmit control information including the second time offset to the R node by including the control information in the data field 420 including a PDRCH for the DR transmission. In another example, the D node may be configured to further include the second time offset in data of the data field 420 including the PDRCH for the DR transmission and transmit the data to the R node. Therefore, the R node may determine a DR transmission time based on the second time offset received from the D node.

In the present disclosure, the information used to calculate or determine the second time offset may include a value ‘N’ for obtaining T_offset2 (i.e. T_ref×N) as an N-times multiple of a specific reference time length T_ref. In this case, the D node may transmit the value N to the R node by including the value N in the PDRCH for the DR transmission or in DR control information of the PDRCH by considering the energy harvesting state. Here, N may be 1. When only one bit is used for N, the one-bit information may be interpreted as information regarding whether an offset is applied.

In another exemplary embodiment, the information used to calculate or determine the second time offset may be related to a transmission periodicity of a message periodically transmitted. For example, when an inventory request message is transmitted with a periodicity T_rep, the second time offset T_offset2 may be calculated or defined as ‘T_rep×N’. The D node may transmit the value N by including the value N in data transmitted through the PDRCH included in the DR transmission or in DR control information. Here, N may be 1. When only one bit is used for N, the one-bit information may be interpreted as information regarding whether an offset is applied.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first device (D) node, comprising:
transmitting, to a reader (R) node, a first message (Msg1) at a first time within a time duration in which transmission of the Msg1 is possible, based on reception of a random access trigger message from the R node;
receiving, from the R node, a second message (Msg2) including information on a resource available for transmission of a third message (Msg3); and
in response to identifying the received Msg2 as a response to the Msg1, transmitting the Msg3 including information on the first D node to the R node, based on the information on the resource available for transmission of the Msg3, which is included in the Msg2,
wherein the first time is a start time of one Internet of Things (IoT) slot among IoT slots obtained by dividing the time duration from a predefined minimum time for transmission of the Msg1 to a predefined maximum time for transmission of the Msg1.

2. The method of claim 1, wherein based on identifying that an IoT slot index for the Msg1 is included in IoT slot index information of the received Msg2, the received Msg2 is identified as the response to the Msg1.

3. The method of claim 2, wherein the resource available for transmission of the Msg3 includes Msg3 transmission slots having a same number as a number of IoT slots available for transmission of the Msg1, and the Msg3 is transmitted in a Msg3 transmission slot among the Msg3 transmission slots, the Msg3 transmission slot having a same slot index as a slot index corresponding to the first time at which the Msg1 is transmitted.

4. The method of claim 1, wherein the Msg2 is received within a time duration in which reception of the Msg2 is possible, the time duration in which reception of the Msg2 is possible being determined based on a predefined maximum time for a first IoT slot among the IoT slots and a predefined minimum time for a last IoT slot among the IoT slots.

5. The method of claim 1, wherein the Msg2 further includes a first time offset for calculating a start time of transmission of the Msg3; based on the first time offset being non-zero, the start time of transmission of the Msg3 is determined based on an end time of transmission of the Msg2 and the first time offset; and based on the first time offset being zero, the start time of transmission of the Msg3 is determined based on the end time of transmission of the Msg2.

6. The method of claim 1, wherein the Msg3 is transmitted at a second time, the second time corresponds to a start time of one slot among a plurality of slots; a first slot among the plurality of slots is determined based on an end time of transmission of the Msg2, a first time offset included in the Msg2, and a predefined minimum time for transmission of the Msg3; and a last slot among the plurality of slots is determined based on the end time of transmission of the Msg2, the first time offset included in the Msg2, and a predefined maximum time for transmission of the Msg3.

7. The method of claim 1, wherein the Msg2 further includes two or more first time offsets indicating start times of transmission of the Msg3 and mapping information between the two or more first time offsets and respective D nodes; and based on existence of a first time offset mapped to the first D node, the Msg3 is transmitted at a time determined based on the first time offset mapped to the first D node.

8. The method of claim 1, wherein the first time is determined as an IoT slot index corresponding to a randomly generated number within a range of a number of the IoT slots.

9. A method of a reader (R) node, comprising:
broadcasting a trigger message instructing performance of a random access (RA) procedure;
receiving, from a device (D) node, a first message (Msg1) within a time duration in which transmission of the Msg1 is possible in response to the trigger message; and
transmitting, to the D node, a second message (Msg2) including information on a resource available for transmission of a third message (Msg3) and response information for the Msg1, based on the received Msg1,
wherein the D node transmits the Msg1 at a first time, and the first time is a start time of one Internet of Things (IoT) slot among IoT slots obtained by dividing the time duration from a predefined minimum time for transmission of the Msg1 to a predefined maximum time for transmission of the Msg1.

10. The method of claim 9, wherein the response information for the Msg1 is indicated by a same slot index as a slot index of the Msg1 transmitted by the D node.

11. The method of claim 10, wherein the resource available for transmission of the Msg3 includes Msg3 transmission slots having a same number as a number of IoT slots available for transmission of the Msg1, and the Msg3 is received in a Msg3 transmission slot among the Msg3 transmission slots, the Msg3 transmission slot having a same slot index as a slot index corresponding to the first time at which the Msg1 is received.

12. The method of claim 9, wherein the Msg2 is transmitted within a time duration in which transmission of the Msg2 is possible, the time duration in which transmission of the Msg2 is possible being determined based on a predefined maximum time for a first slot among the IoT slots and a predefined minimum time for a last slot among the IoT slots.

13. The method of claim 9, wherein the Msg2 further includes a first time offset for calculating a start time of transmission of the Msg3; based on the first time offset being non-zero, the start time of transmission of the Msg3 is determined based on an end time of transmission of the Msg2 and the first time offset; and based on the first time offset being zero, the start time of transmission of the Msg3 is determined based on the end time of transmission of the Msg2.

14. The method of claim 9, wherein the Msg3 is received at a second time, the second time corresponds to a start time of one slot among a plurality of slots; a first slot among the plurality of slots is determined based on an end time of transmission of the Msg2, a first time offset included in the Msg2, and a predefined minimum time for transmission of the Msg3; and a last slot among the plurality of slots is determined based on the end time of transmission of the Msg2, the first time offset included in the Msg2, and a predefined maximum time for transmission of the Msg3.

15. The method of claim 9, wherein the Msg2 further includes two or more first time offsets indicating start times of transmission of the Msg3 and mapping information between the two or more first time offsets and respective D nodes.

16. The method of claim 9, wherein the first time is determined as an IoT slot index corresponding to a randomly generated number within a range of a number of the IoT slots.

17. A first device (D) node comprising at least one processor, wherein the at least one processor causes the first D node to perform:
transmitting, to a reader (R) node, a first message (Msg1) at a first time within a time duration in which transmission of the Msg1 is possible, based on reception of a random access trigger message from the R node;
receiving, from the R node, a second message (Msg2) including information on a resource available for transmission of a third message (Msg3); and
in response to identifying the received Msg2 as a response to the Msg1, transmitting the Msg3 including information on the first D node to the R node, based on the information on the resource available for transmission of the Msg3, which is included in the Msg2,
wherein the first time is a start time of one Internet of Things (IoT) slot among IoT slots obtained by dividing the time duration from a predefined minimum time for transmission of the Msg1 to a predefined maximum time for transmission of the Msg1.

18. The first D node of claim 17, wherein based on identifying that an IoT slot index for the Msg1 is included in IoT slot index information of the received Msg2, the received Msg2 is identified as the response to the Msg1.

19. The first D node of claim 17, wherein the resource available for transmission of the Msg3 includes Msg3 transmission slots having a same number as a number of IoT slots available for transmission of the Msg1, and the Msg3 is transmitted in a Msg3 transmission slot among the Msg3 transmission slots, the Msg3 transmission slot having a same slot index as a slot index corresponding to the first time at which the Msg1 is transmitted.

20. The first D node of claim 17, wherein the Msg2 is received within a time duration in which reception of the Msg2 is possible, the time duration in which reception of the Msg2 is possible being determined based on a predefined maximum time for a first IoT slot among the IoT slots and a predefined minimum time for a last IoT slot among the IoT slots.
